(19) United States
(12) Patent Application Publication
(10) Pub. No.: US 2023/0062833 A1
(43) Pub. Date: Mar. 2, 2023

(54) DRYER, DRYING METHOD, AND DEHUMIDIFICATION FILTER

(71) Applicant: Panasonic Intellectual Property Management Co., Ltd., Osaka (JP)

(72) Inventors: HIDENOBU WAKITA, Kyoto (JP); YASUAKI OKUMURA, Kyoto (JP)

(21) Appl. No.: 18/046,954

(22) Filed: Oct. 17, 2022

Related U.S. Application Data
(63) Continuation of application No. PCT/JP2021/016569, filed on Apr. 26, 2021.

(30) Foreign Application Priority Data
May 14, 2020 (JP) 2020-084890
Feb. 26, 2021 (JP) 2021-029397

(51) Int. Cl. F26B 21/04; F26B 3/04; F26B 9/02; D06F 58/10; D06F 58/20; D06F 58/38; B01D 53/26; B01D 53/28; B01D 53/04; A47L 19/00

(52) U.S. Cl. CPC F26B 21/04; F26B 3/04; F26B 9/02; D06F 58/10; D06F 58/20; D06F 58/38; B01D 53/261; B01D 53/28; B01D 53/0446; B01D 53/0438; B01D 53/0454; A47L 19/00; D06F 2105/30

(57) ABSTRACT

A dryer includes a dehumidification filter containing a temperature responsive material with an upper critical solution temperature, a fan sending gas through the dehumidification filter, a heater heating the dehumidification filter, and a controller controlling the fan and the heater and switching an operation mode of the fan and the heater between a drying mode and a regeneration mode, wherein, in the drying mode, an object to be dried is dried with the fan sending the gas through the dehumidification filter that is heated by the heater to temperature higher than or equal to the upper critical solution temperature, and in the regeneration mode, the dehumidification filter is regenerated with the fan sending the gas through the dehumidification filter at temperature lower than the upper critical solution temperature.

### BACKGROUND

### 1. Technical Field

The present disclosure relates to a dryer and so on.

### 2. Description of the Related Art

In Japan, household electricity consumption occupies ⅓ of total consumption, and higher efficiency of home appliances are demanded to cope with environmental problems such as global warming. Needs for high-performance home appliances are increasing with an increase of double-income households. Drying is one of application fields, such as a bathroom dryer, a dish (tableware) dryer, and a clothes dryer, which have increased rapidly in recent year. Those driers utilize a method of generating heat by an electric heater or a heat pump to dry clothes, dishes, and so on in many cases and consume a lot of energy.

Japanese Patent No. 3259376 discloses a dryer and so on in which a moisture adsorbent is used, and clothes are dried by blowing moisture-removed and dried air (gas) to the clothes. Japanese Patent No. 6569063 discloses an apparatus in which a temperature responsive polymer with a lower critical solution temperature is used, gas is dehumidified by utilizing a hydrophilic function of the temperature responsive polymer at low temperature, and the temperature responsive polymer is heated to become hydrophobic for regeneration.

### SUMMARY

However, the dryer and so on disclosed in Japanese Patent No. 3259376 have a problem with energy saving because of, for example, the necessity of heating gas supplied to regenerate the moisture adsorbent. Generally, the moisture adsorbent exhibits high moisture adsorption performance at low temperature and releases humidity at high temperature. Therefore, the apparatus and so on disclosed in Japanese Patent No. 6569063 have a problem with regeneration of the moisture adsorbent when humidity is to be adsorbed by the moisture adsorbent for drying.

In one general aspect, the techniques disclosed here feature a dryer including a dehumidification filter containing a temperature responsive material with an upper critical solution temperature, a fan sending gas through the dehumidification filter, a heater heating the dehumidification filter, and a controller controlling the fan and the heater and switching an operation mode of the fan and the heater between a drying mode and a regeneration mode, wherein, in the drying mode, an object to be dried is dried with the fan sending the gas through the dehumidification filter that is heated by the heater to temperature higher than or equal to the upper critical solution temperature, and in the regeneration mode, the dehumidification filter is regenerated with the fan sending the gas through the dehumidification filter at temperature lower than the upper critical solution temperature.

The dryer and so on according to one aspect of the present disclosure can efficiently dry objects to be dried.

It should be noted that generic or specific embodiments of the present disclosure may be implemented not only in the form of a method, a system, an integrated circuit, a computer program, or a computer-readable recording medium, but also in any selective combinations of a device, a system, a method, an integrated circuit, a computer program, and a computer-readable recording medium. The computer-readable recording medium includes, for example, a nonvolatile recording medium such as a CD-ROM (Compact Disc-Read Only Memory).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of a dryer according to Embodiment 1;

FIG. 2 is a block diagram illustrating a functional configuration of the dryer according to Embodiment 1;

FIG. 3 is a flow chart for the dryer according to Embodiment 1;

FIG. 4 illustrates operation of the dryer according to Embodiment 1 in a drying mode;

FIG. 5 illustrates operation of the dryer according to Embodiment 1 in a regeneration mode;

FIG. 6 is a graph depicting an example of changes in temperature and humidity inside a bathroom during the operation of the dryer according to Embodiment 1;

FIG. 7 illustrates an example of a dryer according to Comparative Example 1;

FIG. 8 illustrates operation of a dryer according to Comparative Example 2 in a drying mode;

FIG. 9 is a graph depicting an example of changes in temperature and humidity inside the bathroom during the operation of the dryer according to Comparative Example 2;

FIG. 10 is a table indicating power consumptions of the dryers according to Embodiment 1, Comparative Example 1, and Comparative Example 2;

FIG. 11 illustrates operation of a dryer according to Embodiment 2 in a drying mode;

FIG. 12 illustrates operation of the dryer according to Embodiment 2 in a regeneration mode;

FIG. 13 illustrates operation of a dryer according to Embodiment 3 in a drying mode;

FIG. 14 illustrates operation of the dryer according to Embodiment 3 in a regeneration mode;

FIG. 15 illustrates a bedding dryer according to Embodiment 4;

FIG. 16 is a graph representing moisture adsorption amounts of a copolymer of N-acryloyl glycinamide and acrylonitrile under constant temperature and humidity conditions in Embodiment 5; and

FIG. 17 is a graph representing an adsorption isotherm and a desorption isotherm of water vapor for the copolymer of N-acryloyl glycinamide and acrylonitrile in Embodiment 5 with respect to relative pressure, those isotherms being measured by a constant-volume adsorption measurement device.

### DETAILED DESCRIPTIONS

### Underlying Knowledge Forming Basis of the Present Disclosure

In a dryer, blowing high-temperature gas at low humidity to an object to be dried is effective in drying the object. However, because the gas after the drying is humid, drying efficiency decreases if the gas after the drying is reused as it is. When clothes are dried by using the bathroom dryer disclosed in Japanese Patent No. 3259376, part (e.g., ⅓) of the gas used for the drying is discharged and ambient gas is taken into a bathroom from the outside to reduce the humidity for the purpose of preventing a decrease of drying performance caused by the humid gas. This method is disadvantageous from the viewpoint of energy saving because the gas taken into the bathroom has to be warmed and heating of the taken-in gas with a heater or the like needs to be continued for a long time.

Meanwhile, suppressing power consumption with a heat pump is also proposed. According to this method, warmed gas is sent to a cooling side of the heat pump to remove moisture in humid gas, and the gas is reheated after condensation of the moisture. Thus, the proposed method has a room for improvement. The heat pump dryer is problematic in that, because gas is taken into the dryer from a washroom or a toilet, for example, and heat is taken away from there, the indoor heat is taken away, and the heating efficiency is reduced. Another problem is that, because installation work of the heat pump and so on is needed, the heat pump dryer is not suitable for being installed instead of an electric heater dryer.

In a dish dryer as well, gas is taken in from the outside, the taken-in gas is heated by a heater to dry dishes, and humid gas after being used for the drying is discharged to the outside of the dryer. Thus, cold and dry gas has to be taken in from the outside, and improvement of efficiency is demanded in the dish dryer.

Embodiments will be described below with reference to the drawings. It is to be noted that the following embodiments represent generic or specific examples. Numerical values, shapes, materials, constituent elements, layout positions and connection forms of the constituent elements, steps, order of the steps, etc., which are described in the following embodiments, are merely illustrative, and they are not purported to limit the scope of Claims. Furthermore, ones of the constituent elements in the following embodiments, those ones being not stated in independent claims, are explained as optional constituent elements.

The drawings are schematic views and are not always exactly drawn in a strict sense. In the drawings, substantially the same constituent elements are denoted by the same reference sings, and duplicate description of those constituent elements is omitted or simplified in some cases.

### Embodiment 1

### Configuration of Dyer

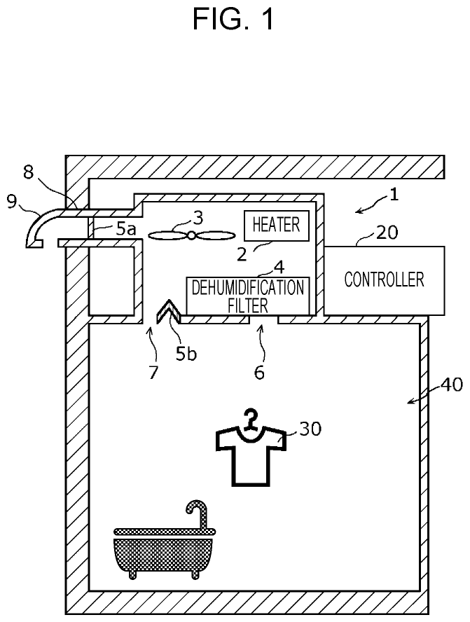

FIG. 1 illustrates an example of a dryer 1 according to Embodiment 1. The dryer 1 according to this embodiment is constructed as a bathroom dryer. The dryer 1 includes a heater 2, a fan 3, a dehumidification filter 4, a damper 5a, a louver 5b, a discharge passage 8, a ventilation port 9, and a controller 20. The dehumidification filter 4 is disposed near a blow-out port 6. The blow-out port 6 can be opened and closed. Inside the dryer 1, for instance, the heater 2 is disposed on an opposite side to the blow-out port 6 with the dehumidification filter 4 sandwiched therebetween, and the fan 3 is disposed on a side closer to the discharge passage 8 when viewed from the dehumidification filter 4. In this case, the heater 2 is positioned above the dehumidification filter 4. The louver 5b is disposed in an suction port 7, and the damper 5a is disposed in the discharge passage 8. The blow-out port 6 and the suction port 7 are disposed at location where a space 40 (i.e., a bathroom) in which an object 30 to be dried is present and the dryer 1 are adjacent to each other. In this embodiment, the object 30 to be dried is represented by laundry.

In a drying mode of the dryer 1, the controller 20 controls the fan 3 to send gas along a gas flow path through which the gas in the bathroom is received into the dryer 1 from the suction port 7 and the gas is supplied into the bathroom from the blow-out port 6. This gas flow path is a practical example of a first flow path. Here, the drying mode is a mode in which heated gas is supplied from the dryer 1 to the space 40 in which the object 30 to be dried is present, thus drying the object 30 to be dried.

The dehumidification filter 4 includes a temperature responsive polymer with an upper critical solution temperature, and the temperature responsive polymer has a corrugated honeycomb structure. A moisture removing/adsorbing agent in the dehumidification filter 4 is the temperature responsive polymer of which affinity with moisture is reversibly changed in response to heat. More specifically, that agent is a polymer with an upper critical solution temperature (UCST). The polymer with the upper critical solution temperature is hydrophobic at low temperature and becomes hydrophilic at temperature higher than or equal to the upper critical solution temperature. Here, the term “upper critical solution temperature” indicates a temperature at which the polymer becomes hydrophilic and dissolvable when it is dispersed into water. When the temperature responsive polymer with the upper critical solution temperature is heated by the heater 2, its temperature becomes higher than or equal to the upper critical solution temperature and its property is changed from hydrophobic to hydrophilic. The dehumidification filter 4 containing the temperature responsive polymer having become hydrophilic exhibits dehumidification performance and removes water vapor evaporated from the object 30 to be dried. Thus, the dryer 1 obtains high-temperature and low-humidity gas. The dryer 1 supplies the gas at high temperature and low humidity to the space 40 in which the object 30 to be dried is present.

Because moisture is evaporated from the laundry, heat absorption occurs in the space 40. Because water vapor is adsorbed by the dehumidification filter 4, heat emission occurs in the dehumidification filter 4. The dryer 1 only releases heat into the bathroom without discharging hot gas to the outdoor. Accordingly, when the controller 20 continues to supply a current to the heater 2, temperature keeps rising in both the dehumidification filter 4 and the bathroom. In consideration of the above point, the controller 20 stops the supply of the current to the heater 2 at temperature (e.g., 40° C.) which is higher than or equal to the upper critical solution temperature and at which the temperature in the bathroom does not become too high.

When the temperature of the dehumidification filter drops to the upper critical solution temperature or lower due to heat dissipation to the outside of the bathroom, intermittent supply of the current is performed, for example, by restarting the supply of the current to the heater 2.

The dehumidification filter 4 may be an exchangeable dehumidification unit.

In a regeneration mode of the dryer 1, the controller 20 makes control to open the damper 5a, to close the louver 5b disposed in the suction port 7, and to operate the fan 3 to send gas along a gas flow path through which the gas is discharged to the outdoor from the blow-out port 6. This gas flow path is a practical example of a second flow path. With the gas flowing through the temperature responsive polymer with the upper critical solution temperature from the space 40 in which the object 30 to be dried is present, the temperature of the temperature responsive polymer drops to the upper critical solution temperature or below, and the polymer property is changed from hydrophilic to hydrophobic. The dehumidification filter 4 containing the temperature responsive polymer having become hydrophobic releases moisture, and the dehumidification performance is regenerated. When it does not matter if a long time is taken for the regeneration, the fan 3 needs not to be operated during the regeneration.

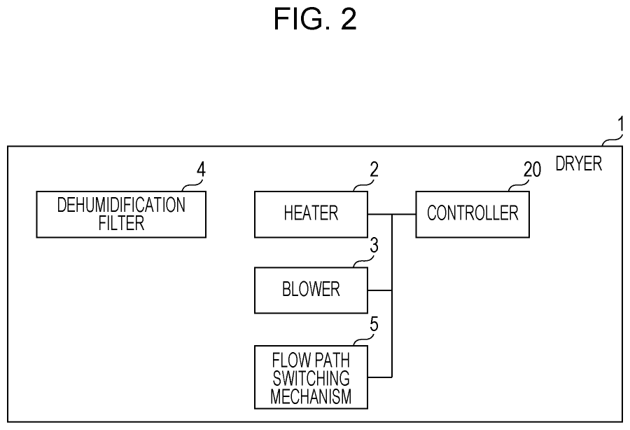

FIG. 2 is a block diagram illustrating a functional configuration of the dryer 1 according to Embodiment 1. As described with reference to FIG. 1, the dryer 1 includes the dehumidification filter 4, the heater 2, the fan 3, a flow path switching mechanism 5, and the controller 20. The flow path switching mechanism 5 includes the damper 5a and the louver 5b. The controller 20 is electrically connected to the heater 2, the fan 3, and the flow path switching mechanism 5 and controls operations of those components.

### Process Performed by Dryer

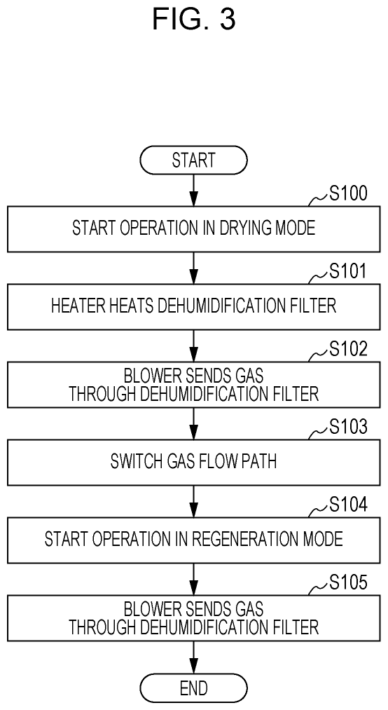

The process performed by the dryer 1 will be described below. FIG. 3 is a flow chart for the dryer 1 according to Embodiment 1.

First, the dryer 1 starts operation in the drying mode (step S100). The controller 20 starts control of the heater 2, the fan 3, and the flow path switching mechanism 5 to start the operation in the drying mode. More specifically, for instance, the controller 20 closes the damper 5a and opens the louver 5b.

Then, the heater 2 heats the dehumidification filter 4 (step S101). The controller 20 supplies a current to the heater 2. The heater 2 is warmed with the supply of the current and heats the dehumidification filter 4, disposed near the heater 2, to the upper critical solution temperature or higher.

Then, the fan 3 sends gas through the dehumidification filter 4 (step S102). The controller 20 controls the fan 3 such that the gas received from the space 40 is supplied to the space 40 after flowing through the heater 2 and the dehumidification filter 4. The gas having flowed through the dehumidification filter 4 is dehumidified and becomes high-temperature and low-humidity gas. This is because the dehumidification filter 4 heated to the upper critical solution temperature or higher becomes hydrophilic and exhibits the dehumidification performance. In other words, when gas flows through the dehumidification filter 4 at temperature higher than the upper critical solution temperature, moisture contained in the gas is adsorbed by the dehumidification filter 4 with the dehumidification performance, whereby the gas comes into a high-temperature and low-humidity state. This high-temperature and low-humidity gas is supplied to the space 40 and can dry the object 30 to be dried. Alternatively, in the dryer 1, the fan 3 may send gas, and the heater 2 may warm the sent gas, and the dehumidification filter 4 may be heated to the upper critical solution temperature or higher by causing the warmed gas to flow through the dehumidification filter 4.

Then, the controller 20 switches a gas flow path (step S103). The controller 20 controls the flow path switching mechanism 5 to switch the gas flow path from a flow path in the drying mode to a flow path in the regeneration mode. More specifically, for instance, the controller 20 opens the damper 5a and closes the louver 5b.

Then, the dryer 1 starts operation in the regeneration mode (step S104). The controller 20 starts control of the heater 2, the fan 3, and the flow path switching mechanism 5 to start the operation in the regeneration mode.

Then, the fan 3 sends gas through the dehumidification filter 4 (step S105). The controller 20 controls the fan 3 such that the gas in the space 40 is received through the blow-out port 6 and flows through the dehumidification filter 4. With the fan 3 sending the gas through the dehumidification filter 4, the dehumidification performance of the dehumidification filter 4 is regenerated. The reason is as follows. Because the gas in the space 40 at temperature having dropped due to heat absorption during the drying of the laundry flows through the dehumidification filter 4, the temperature of the dehumidification filter 4 drops to a level lower than the upper critical solution temperature, and the dehumidification filter 4 becomes hydrophobic. Therefore, the dehumidification filter 4 releases moisture having been adsorbed so far and restores the moisture adsorption performance again.

As described above, in the dryer 1, by causing gas to flow through the dehumidification filter 4 using the temperature responsive polymer with the upper critical solution temperature, the high-temperature and low-humidity gas is produced and supplied to the space 40. Furthermore, in the dryer 1, by causing the gas received from the space 40 to flow through the dehumidification filter 4, the dehumidification performance of the dehumidification filter 4 is regenerated.

When the laundry hanging on an inner wall of the bathroom or inside the bathroom is dried by using the above-described dryer 1, preliminary drying is performed prior to the start of the drying mode without supplying the current to the heater 2, and the inside of the bathroom is dried with relatively small electric power. The preliminary drying indicates both ventilation operation (sending of gas from the suction port 7 to the ventilation port 9) and circulation operation (sending of gas from the suction port 7 to the blow-out port 6) prior to the supply of the current to the heater 2. The above-mentioned control is not illustrated in FIG. 3. After the above-described control, step S100 illustrated in FIG. 3 is performed. Thus, the dryer 1 performs switching control to start the operation in the drying mode that is executed by supplying the current to the heater 2.

During the ventilation prior to the operation in the drying mode, the dryer 1 discharges the gas inside the bathroom in a state in which the damper 5a is opened and the blow-out port 6 is closed. During the circulation operation, the dryer 1 is operated in a state in which the damper 5a is closed and the blow-out port 6 is opened. The dryer 1 can perform the preliminary drying prior to the operation in the drying mode even in a state in which the blow-out port 6 is opened and the damper 5a is opened.

When a humidity sensor (not illustrated) is disposed in the dryer 1 and a detection signal from the humidity sensor is input to the controller 20, the controller 20 can stop the preliminary drying and can make switching to the operation in the drying mode when the humidity inside the bathroom drops to a predetermined value or below.

During the operation in the drying mode, the controller 20 closes the damper 5a, opens the suction port 7 and the blow-out port 6, and supplies the current to the heater 2, thereby heating the inside of the bathroom and the dehumidification filter 4 while the gas is circulated through the fan 3.

With the controller 20 supplying the current to the heater 2, the dehumidification filter 4 is heated to the upper critical solution temperature or higher, and its property is changed from hydrophobic to hydrophilic. The dehumidification filter 4 having become hydrophilic exhibits the dehumidification performance and removes water vapor from the gas evaporated from the laundry and containing the water vapor. As a result, the dryer 1 obtains the high-temperature and low-humidity gas.

Because moisture is evaporated from the laundry, heat absorption occurs in the space 40. Because water vapor is adsorbed by the dehumidification filter 4, heat emission occurs in the dehumidification filter 4. The dryer 1 only releases heat (an amount of the heat release is assumed to be 34 W) into the bathroom without discharging hot gas to the outdoor. Accordingly, when the controller 20 continues to supply the current to the heater 2, temperature keeps rising in both the dehumidification filter 4 and the bathroom. In consideration of the above point, the controller 20 stops the supply of the current to the heater 2 at temperature (e.g., 40° C.) which is higher than or equal to the upper critical solution temperature and at which the temperature in the bathroom does not become too high. When the temperature of the dehumidification filter drops to the upper critical solution temperature or lower due to heat dissipation to the outside of the bathroom, intermittent supply of the current to the dryer 1 is performed, for example, by restarting the supply of the current to the heater 2.

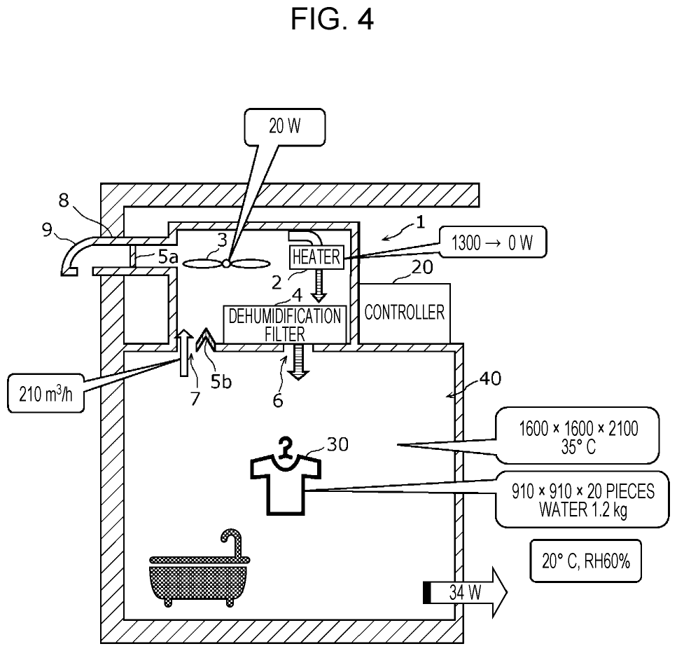

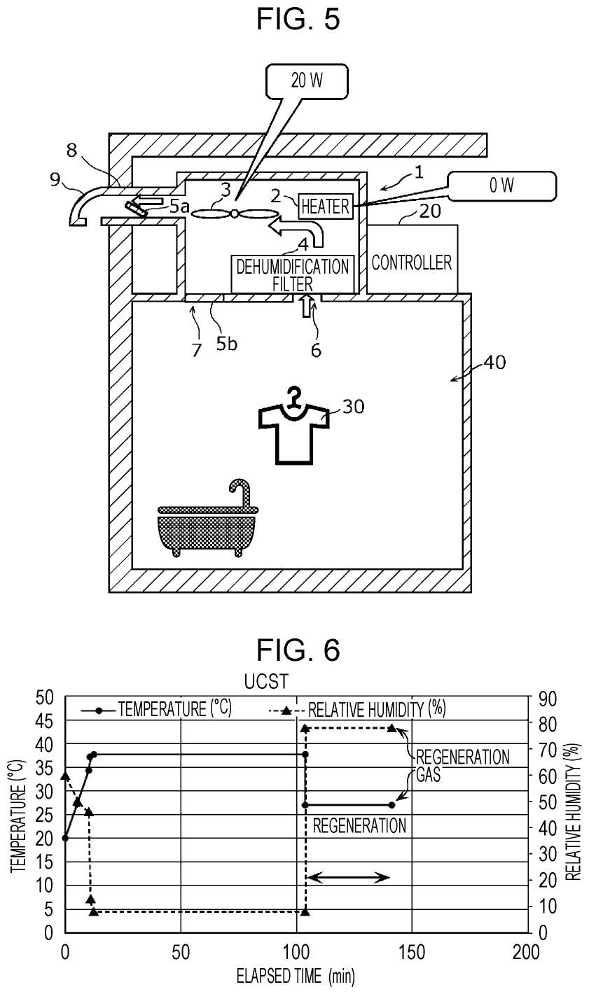

FIG. 4 illustrates the operation of the dryer 1 according to Embodiment 1 in the drying mode, and FIG. 5 illustrates the operation of the dryer 1 according to Embodiment 1 in the regeneration mode. FIG. 6 illustrates an example of changes in temperature and humidity inside the bathroom during the operation of the dryer 1 according to Embodiment 1. FIG. 6 illustrates heat balance when a bathroom of 1600 mm×1600 mm×2100 mm (height) is dried by the dryer 1 including the fan 3 of 20 W and the heater 2 of 1300 W in accordance with the drying test method BLT HS/B-b-701 that is published from the General Incorporated Association Center for Better Living. As illustrated in FIGS. 4 and 5, 1.2 kg of water is absorbed into dummy cotton laundry of 910 mm×910 mm (weight 100 g per piece, total 20 pieces). The following description is made in connection with the case in which the ambient temperature is set to 20° C., the relative humidity is set to 60%, the amount of the heat release is set to 34 W, and the dryer 1 circulates the gas inside the bathroom at 210 m³/h. The dehumidification filter 4 is given as a corrugated honeycomb of 281 mm×410 mm×54 mm (height) that includes 600 cell/inch and that bears copolymeric macromolecules of acrylamide and acrylonitrile with the upper critical solution temperature of 35° C. The thermal capacity of the dehumidification filter 4 is assumed to be 35.4 kJ/K.

Let consider the case of starting the operation in the drying mode in which the controller 20 closes the damper 5a and supplies the current to the heater 2, after the preliminary drying prior to the supply of the current to the heater 2 with intent to dry the laundry under conditions that the ambient temperature is 20° C. and the relative humidity is 60%. As illustrated in FIG. 4, the gas in the space 40 is received through the suction port 7 and is sent to the heater 2 by the fan 3. After being heated by the heater 2, the gas flows through the dehumidification filter 4 and is supplied to the space 40 from the blow-out port 6. As illustrated in FIG. 6, with the supply of the current to the heater 2, temperature rises in the dehumidification filter 4 and the space 40, and evaporation of moisture starts. However, the humidity drops a little. For 10 min at the beginning, dehumidification does not occur because the temperature of the dehumidification filter 4 is lower than or equal to 35° C. Then, the temperature of the dehumidification filter 4 becomes the upper critical solution temperature or higher, and the dehumidification starts. Here, the upper critical solution temperature is, for example, 35° C.

Thereafter, slight heat dissipation occurs in the bathroom while the dehumidification filter 4 emits heat due to condensation heat. Therefore, even with the controller 20 stopping the supply of the current to the heater 2, the temperature of the dehumidification filter 4 is hardly changed. However, because moisture is dissipated to the outside of the bathroom, the current is intermittently supplied to the heater 2 to keep the temperature of the dehumidification filter 4 at 37° C. It is here assumed that moisture adsorption in the dehumidification filter 4 does not become a rate-determining factor. If it is assumed that constant-rate drying is performed, a drying time is estimated to be about 1.7 hour based on the linear speed, temperature, and humidity of the gas and the size of the laundry. Power consumption during the dehumidification is estimated to be 422 Wh.

During the operation of the dryer 1 in the regeneration mode to regenerate the dehumidification filter 4, for instance, the controller 20 causes the gas in the space 40 to flow through the dehumidification filter 4 at temperature lower than or equal to the upper critical solution temperature without supplying the current to the heater 2. As illustrated in FIG. 5, the controller 20 closes the suction port 7, opens the blow-out port 6, opens the damper 5a, and operates the fan 3 such that the gas flows to the outdoor from the bathroom.

Assuming that the constant-rate drying is performed when the dryer 1 supplies the gas at 210 m³/h to regenerate the dehumidification filter 4 on condition of a certain apparent surface area of the corrugated honeycomb, the bathroom temperature of 27° C., and the relative humidity of 78%, the apparent surface area being calculated on condition that an outer surface area of corrugated honeycomb with 600 cell/inch is 4800 m²/m³, an estimated drying time is within 1 hour. A region denoted by “REGENERATION” in the graph of FIG. 6 indicates temperature and humidity inside the bathroom during the operation in the regeneration mode.

If calculation is made on an assumption that power consumption of the preliminary drying at the beginning of the operation is 20 W and an operation time is 6 hours, power consumption including the preliminary drying prior to the supply of the current to the heater 2, the operation in the drying mode, and the operation in the regeneration mode is 556 Wh.

While the present disclosure has been described in connection with the example in which heating is performed by the heater 2, the dryer 1 may also perform the heating by using a heat pump. In that case, by using the dehumidification filter 4 with the upper critical solution temperature, the dryer 1 can circulate warmed gas into the bathroom without cooling the warmed gas by the dehumidification filter 4. Therefore, as in the case of using the heater 2, the dryer 1 can realize the dehumidification only with the circulation of warm gas by stopping the heat pump after the gas in the bathroom has been heated.

The example of drying the dummy cotton laundry containing water of 1.2 kg has been described above. However, if the water content is smaller, the laundry is dried more quickly, and the dehumidification filter 4 does no longer emit heat after the end of the drying. The operation mode can also be shifted to the regeneration mode by detecting temperature change of the dehumidification filter 4.

### COMPARATIVE EXAMPLE 1

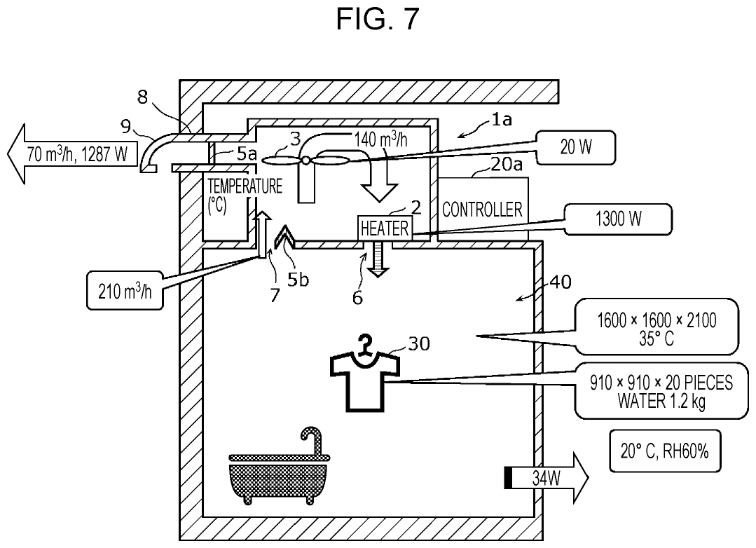

Outline of a dryer 1a not including the dehumidification filter 4 will be described below. FIG. 7 illustrates an example of the dryer 1a according to Comparative Example 1.

During the operation of the dryer 1a in the drying mode, the gas in the bathroom is sucked at 210 m³/h through the suction port 7 and is discharged at 70 m³/h through the discharge passage 8 in communication with the outdoor. Furthermore, the gas is returned at 140 m³/h to the bathroom through the gas flow path from the blow-out port 6 on the downstream side of the gas flow path. The heater 2 is disposed above the blow-out port 6.

As in Embodiment 1, after the preliminary drying operation prior to the operation in the drying mode, a controller 20a supplies a current to the heater 2 (1300 W) and the dryer 1a performs the operation in the drying mode under the above-described conditions.

Assuming that the dryer 1a is operated in the drying mode under similar conditions to those in Embodiment 1, that a temperature rising process is ignored, that the ambient temperature is 20° C. and the relative humidity is 60%, that the amount of the heat release is 34 W, and that the constant-rate drying is performed after the temperature in the bathroom reaches 35° C., an estimated drying time is 2 hours.

If calculation is made on an assumption that the power consumption of the preliminary drying at the beginning of the operation in the drying mode is 20 W and the operation time is 6 hours, power consumption of the dryer 1a is 2760 Wh and is greater than that in Embodiment 1 using the dehumidification filter 4 made of the material with the upper critical solution temperature.

### COMPARATIVE EXAMPLE 2

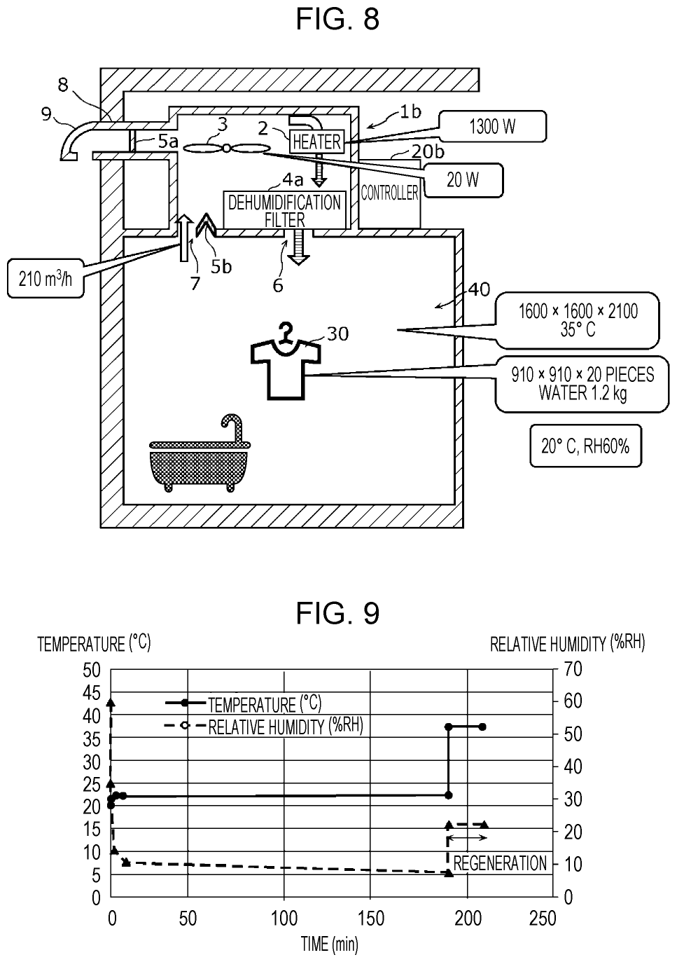

A dryer 1b using a dehumidification filter 4a made of a material with a lower critical solution temperature will be described below. FIG. 8 illustrates operation of the dryer 1b according to Comparative Example 2 in a drying mode. For the dryer 1b, calculation is made on an assumption that a controller 20b does not supply a current to the heater 2 during the drying and supplies the current during the regeneration.

Assuming that the dryer 1b is operated in the drying mode under similar conditions to those in Embodiment 1 with the controller 20b not supplying the current to the heater 2, that the ambient temperature is 20° C. and the relative humidity is 60%, and that the constant-rate drying is performed, an estimated drying time is 3.3 hours. Operation conditions in Comparative Example 2 are similar to those in Embodiment 1. Namely, the controller 20b closes the damper 5a, and the dryer 1b circulates the gas in the bathroom. Changes in temperature and humidity over time are depicted in FIG. 9. FIG. 9 is a graph depicting an example of the changes in temperature and humidity inside the bathroom during the operation of the dryer 1b according to Comparative Example 2. In the dryer 1b, because the heating is not performed during the operation in the drying mode, the dried state of the laundry is estimated to be inferior to that in Embodiment 1 and Comparative Example 1, but the power consumption during the operation in the drying mode is 52 W and is smaller than that in Embodiment 1 and Comparative Example 1. In Comparative Example 2, however, the heating by the dryer 1b is needed during the regeneration of the dehumidification filter 4a. It is here assumed that a corrugated honeycomb of the dehumidification filter 4a bears poly-N-isopropyl acrylamide with the lower critical solution temperature of 32° C. and the thermal capacity is the same as in Embodiment 1. In this case, taking into account evaporation of 1.2 kg of water, heating for 16 min is required when the dehumidification filter 4a is heated by the heater 2 of 1300 W to 37° C. for the regeneration. On that occasion, air at 20° C. with the relative humidity of 60% is heated to 37° C., and temperature and humidity in such a process are depicted in FIG. 9. In Comparative Example 2, taking into account the preliminary drying, the operation in the drying mode, and the operation in the regeneration mode, it is found the dryer 1b needs power consumption of 534 Wh for each cycle of drying. This power consumption is smaller than that in Embodiment 1 using the dehumidification filter 4 with the upper critical solution temperature. However, Comparative Example 2 has a problem that moisture remains on the laundry as described above.

In Comparative Example 3, unlike the configuration illustrated in FIGS. 7 and 8, positions of the heater 2 and the dehumidification filter 4a may be exchanged to be able to supply heated gas during the regeneration of the dehumidification filter 4a. This, however, gives rise to a problem that, because the fan 3 supplies the heated gas to the dehumidification filter 4a at low temperature, the surface of the dehumidification filter 4a is dried earlier, and drying up to the inner side of a resin layer cannot be realized. By contrast, when the material with the upper critical solution temperature is used, the drying can be performed by causing the low-temperature gas to flow through the dehumidification filter 4 that is sufficiently heated. Accordingly, the problem that only a skin layer is dried and the inner side of the resin layer is not dried is less likely to occur.

### Power Consumptions of Dryer

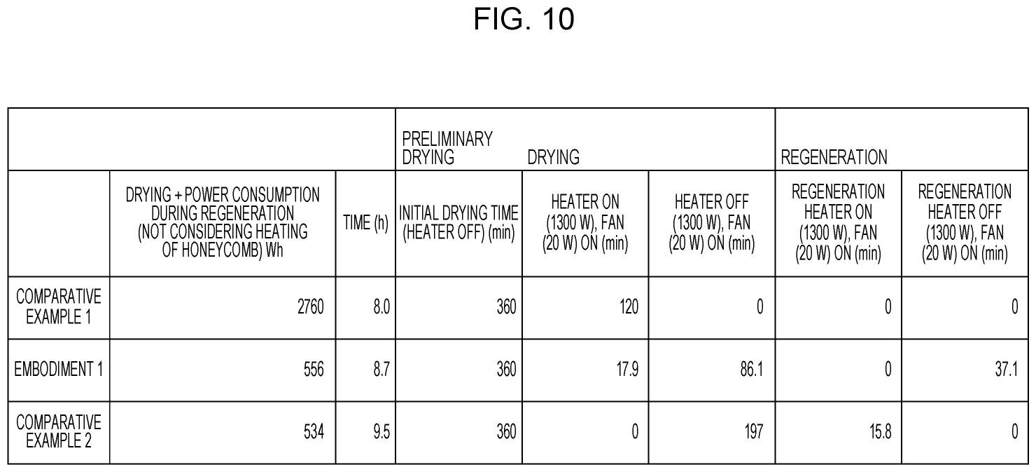

The power consumptions of the dryer 1 according to Embodiment 1, the dryer 1a according to Comparative Example 1, and the dryer 1b according to Comparative Example 2 are described here. FIG. 10 is a table indicating the power consumptions of the dryers according to Embodiment 1, Comparative Example 1, and Comparative Example 2.

In the dryer 1a according to Comparative Example 1, during the preliminary drying, the current is not supplied to the heater 2 and the fan 3 is operated for 360 min. Thereafter, the heater 2 and the fan 3 are operated for 120 min as the operation in the drying mode. Because the dryer 1a does not include the dehumidification filter 4 or 4a, the operation in the regeneration mode is not performed. A total operation time of the dryer 1a is 8 hours, and total power consumption in the preliminary drying and the operation in the drying mode is 2760 Wh.

In the dryer 1 according to Embodiment 1, during the preliminary drying, the current is not supplied to the heater 2 and the fan 3 is operated for 360 min. Thereafter, the heater 2 and the fan 3 are operated for 10 min as the operation in the drying mode, and the fan 3 is then operated for 86 min while the current is intermittently supplied to the heater 2. Subsequently, the fan 3 is operated for 37 min as the operation in the regeneration mode without supplying the current to the heater 2. A total operation time of the dryer 1 is 8.7 hours, and total power consumption in the preliminary drying, the operation in the drying mode, and the operation in the regeneration mode is 556 Wh.

In the dryer 1b according to Comparative Example 2, during the preliminary drying, the current is not supplied to the heater 2 and the fan 3 is operated for 360 min. Thereafter, the fan 3 is operated for 197 min as the operation in the drying mode. Subsequently, the heater 2 and the fan 3 are operated for 15.8 min. A total operation time of the dryer 1b is 9.5 hours, and total power consumption in all the preliminary drying, the operation in the drying mode, and the operation in the regeneration mode is 534 Wh.

As described above, the power consumption of the dryer 1 according to Embodiment 1 is smaller than that of the dryer 1a according to Comparative Example 1 and is slightly greater than that of the dryer 1b according to Comparative Example 2. The dried state of the laundry is superior in Embodiment 1 to Comparative Example 2.

### Embodiment 2

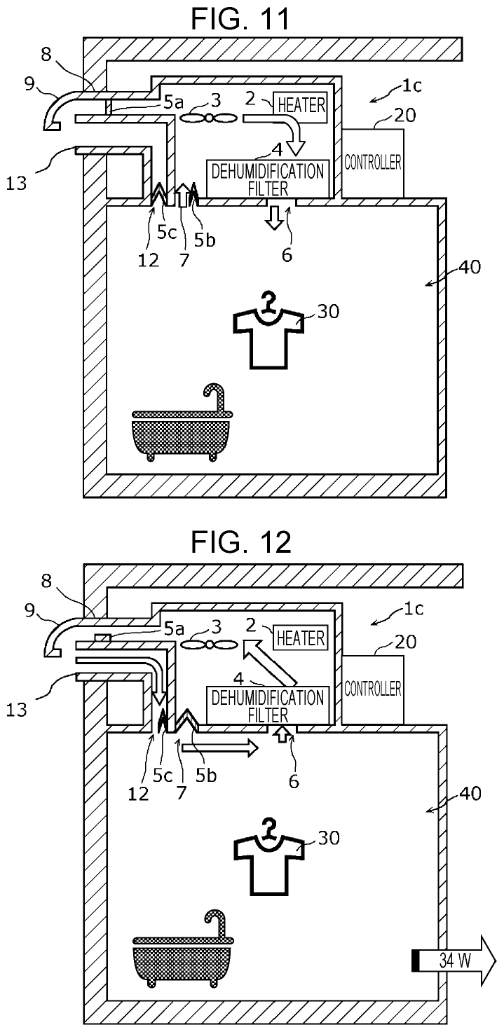

A dryer 1c supplying the gas for use in the regeneration from the outdoor will be described below. FIG. 11 illustrates operation of the dryer 1c according to Embodiment 2 in a drying mode. FIG. 12 illustrates operation of the dryer 1c according to Embodiment 2 in a regeneration mode. The dryer 1c includes an outdoor gas supply port 12 separately from the blow-out port 6, and an outdoor gas supply pipe 13 in communication with the outdoor gas supply port 12 and the ventilation port 9 is disposed parallel to the discharge passage 8. The outdoor gas supply pipe 13 is a practical example of a pipe. A louver 5c is disposed in the outdoor gas supply port 12. In the dryer 1c, during preliminary drying and operation in the drying mode, the controller 20 closes the outdoor gas supply port 12. Thus, the fan 3 sends gas, received from the suction port 7, through the heater 2 and the dehumidification filter 4 and supplies the gas to the space 40 from the blow-out port 6. During the operation of the dehumidification filter 4 in the regeneration mode, the controller 20 makes control as follows. The louver 5c disposed in the outdoor gas supply port 12 is opened to take outdoor gas into the space 40 through the outdoor gas supply pipe 13. Furthermore, the louver 5b is closed to close the suction port 7, the blow-out port 6 is opened, and the fan 3 is operated such that gas received through the blow-out port 6 flows from the dehumidification filter 4 toward the outdoor through the ventilation port 9. In other words, the dryer 1c utilizes the outdoor dry gas to regenerate the dehumidification filter 4. As a result, the dryer 1c can prevent humid gas from being introduced to the bathroom.

### Embodiment 3

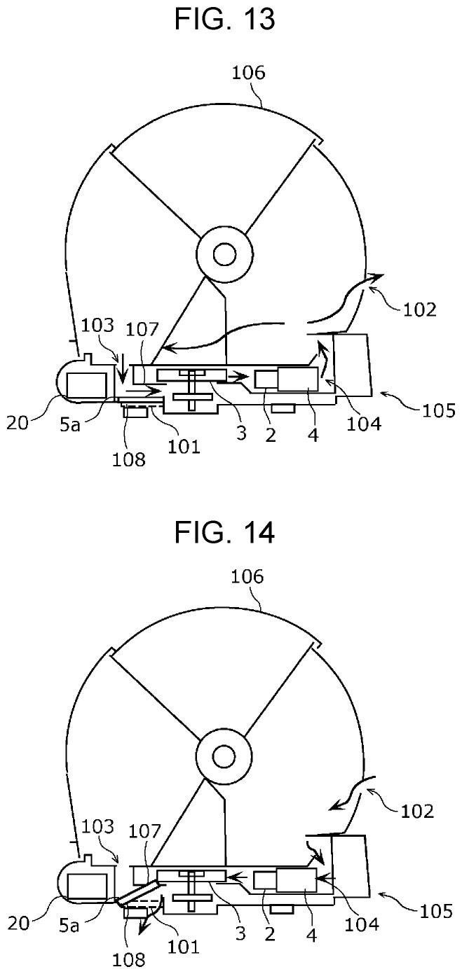

FIG. 13 illustrates operation of a dryer 105 according to Embodiment 3 in a drying mode. The dryer 105 according to this embodiment is constructed as a dish (tableware) dryer. The dryer 105 incorporates a warm gas supply unit composed of a fan 3 capable of sending gas in forward and backward directions and a heater 2, and a dehumidification filter 4 made of a corrugated honeycomb using, as a moisture adsorbent, the temperature responsive polymer with the upper critical solution temperature. A cover 106 is composed of three cover pieces that are slidably supported by the dryer 105, and a dish basket is disposed within the cover 106.

An opening 101 is formed in a bottom surface of the dryer 105. In a related-art dryer, gas is taken in through the opening 101 and the gas heated by the heater 2 is supplied through a supply passage 104 by the fan 3 while gas containing moisture is discharged from a discharge port 102 that is formed in the cover 106.

In the dryer 105 according to the present disclosure, the discharge port 102 is smaller than that in the related-art dryer, and most of the gas after being used to dry dishes in the dryer 105 can be supplied to a circulation gas supply port 103. The dryer 105 includes a damper 108 that opens a circulation gas flow path 107 when the opening 101 is closed, and that closes a route formed by the circulation gas flow path 107 when the opening 101 is opened.

During the operation of the dryer 105 in the drying mode (i.e., a mode of drying the dishes and so on in the dish basket), the controller 20 controls the damper 108 to be shifted to a position at which the opening 101 is closed and the circulation gas flow path 107 is opened. Furthermore, the controller 20 controls the fan 3 to send gas to the heater 2 and to supply the current to the heater 2, whereupon the heater 2 heats the dehumidification filter 4. As in Embodiment 1, the material with the upper critical solution temperature is used as the dehumidification filter 4. Therefore, when the dehumidification filter 4 is heated to high temperature, the dehumidification filter 4 can remove moisture. The fan 3 sends the heated gas through the dehumidification filter 4 that is heated to exhibit the dehumidification performance, and high-temperature and low-humidity gas is supplied from the supply passage 104. Part of the gas after being used to dry the dishes in the dryer 105 is discharged through the discharge port 102, but most of that gas flows through the circulation gas flow path 107 and is supplied to the dehumidification filter 4 through the fan 3. In such a manner, the dryer 105 dries the dishes and so on in the dryer 105. On that occasion, in the dryer 105, because the dehumidification filter 4 emits heat due to condensation heat as described in Embodiment 1, the heating by the heater 2 is not needed, and a power output to the heater 2 can be reduced. As a result, the dryer 105 can supply the high-temperature and low-humidity gas in an energy saving fashion.

The operation of the dryer 105 in the regeneration mode will be described below. FIG. 14 illustrates the operation of the dryer 105 according to Embodiment 3 in the regeneration mode. After the end of the drying of the dishes, the controller 20 controls the damper 108 to open the opening 101. More specifically, the controller 20 shifts the damper 108 to a side where the circulation gas flow path 107 is closed, and further controls the fan 3 such that the gas flows toward the opening 101 from a side including the heater 2. Then, the dryer 105 discharges, from the opening 101, moisture containing gas after being used to regenerate the dehumidification filter 4. As a result, the dryer 105 can take in low-temperature dry gas through the discharge port 102 and can regenerate the dehumidification filter 4 without returning the humid gas to the dishes.

### Embodiment 4

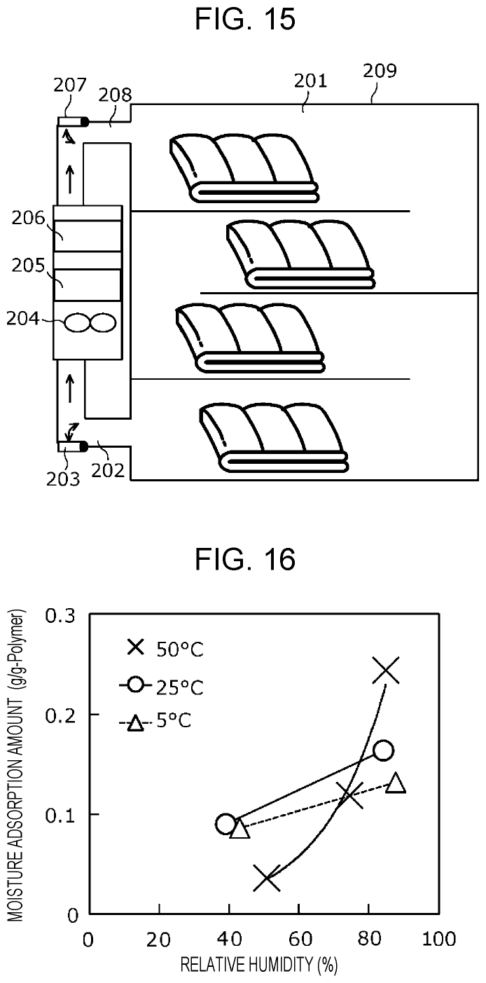

FIG. 15 illustrates operation of a commercial bedding dryer 209 according to Embodiment 4 in a drying mode. The bedding dryer 209 incorporates a warm gas supply unit composed of a fan 204 capable of sending gas and a heater 205, and a dehumidification filter 206 made of a corrugated honeycomb using, as a moisture adsorbent, the temperature responsive polymer with the upper critical solution temperature.

The bedding dryer 209 includes a damper 203 capable of taking in air from the outside and a damper 207 capable of releasing humid air during the regeneration.

In the bedding dryer 209 according to the present disclosure, when the dampers 203 and 207 are set to positions at which communication with the outside of the bedding dryer 209 is cut off (state of FIG. 15), air can be sent by the fan 204 to flow upward from below the fan 204 in FIG. 15 and can be circulated through a bedding storage space 201.

During the operation of the bedding dryer 209 in the drying mode, the bedding dryer 209 sets the dampers 203 and 207 to the positions illustrated in FIG. 15, operates the fan 204 to send the gas toward the heater 205 from the fan 204, and supplies a current to the heater 205, whereupon the heater 205 heats the dehumidification filter 206.

As in Embodiment 1, the material with the upper critical solution temperature is used as the dehumidification filter 206. Therefore, when the dehumidification filter 206 is heated to high temperature, the dehumidification filter 206 can remove moisture. The fan 204 sends heated gas through the dehumidification filter 206 that is heated to exhibit the dehumidification performance, and high-temperature and low-humidity gas is supplied from a circulation gas flow path 208. The gas after being used to dry beddings in the bedding storage space 201 is supplied to the dehumidification filter 206 again after flowing through the circulation gas flow path 202 and the fan 204. In such a manner, the bedding dryer 209 dries the beddings and so on in the bedding storage space 201.

On that occasion, in the bedding dryer 209, because the dehumidification filter 206 emits heat due to adsorption heat as described in Embodiment 1, the heating by the heater 205 can be intermittently performed, and a power output to the heater 205 can be reduced. As a result, the bedding dryer 209 can supply the high-temperature and low-humidity gas to the bedding storage space 201 in an energy saving fashion.

The operation of the bedding dryer 209 in the regeneration mode will be described below. After the end of the drying, the damper 203 or 207 is controlled to cut off the communication between a space in which the fan 204, the heater 205, and the dehumidification filter 206 are present and the bedding storage space 201 and to open a flow path in communication with a space outside the bedding dryer 209. The fan 204 is then controlled such that air flows from the heater 205 to the dehumidification filter 206. Thus, in the bedding dryer 209, moisture containing gas after being used to regenerate the dehumidification filter 206 is discharged to the outside of the bedding dryer 209. As a result, the bedding dryer 209 can take in low-temperature dry gas and can regenerate the dehumidification filter 206 without returning the humid gas to the bedding storage space 201.

### Embodiment 5

Generally, a polymer with the upper critical solution temperature in an aqueous solution has such a tendency that the upper critical solution temperature rises at a higher polymer concentration in the aqueous solution. In consideration of the above point, a copolymer of N-acryloyl glycinamide and acrylonitrile disclosed in Florian K. et at, Polymer Chemistry, 55 274 (2017), the copolymer having the stable upper critical solution temperature even in an aqueous solution with a high concentration, was synthesized. A mixing ratio of the acrylonitrile was set to 33 mol %. The upper critical solution temperature of an aqueous solution of the 1 wt % polymer was 38° C., and the peak molecular weight was 12000 in terms of pullulan.

A sample dried at 70° C. for one day under a vacuum was pulverized in air and was stored in a desiccator under an N₂ gas flow. Thereafter, 0.1 g of the sample was weighed and taken out on a peri dish and was left to stand for half a day under various constant temperature and humidity conditions. The sample was then taken out and weighed immediately. Prior to putting the sample into a high or low temperature state, the sample was left to stand for half a day under conditions of 25° C. with the relative humidity of 40% once. The obtained results are depicted in FIG. 16. As seen from FIG. 16, a moisture adsorption amount is greater at high temperature than at low temperature in a high-humidity environment.

The above results are attributable to the fact that the polymer is swollen under a high-temperature and high-humidity condition and macro-holes are generated between polymer chains. On the other hand, at the low temperature, it is estimated that the polymer remains shrunk even at the high humidity. While it is inferred that the moisture adsorption amount of the moisture adsorbent increases at higher humidity and decreases at lower humidity and that an adsorption isotherm is not greatly changed even with change in temperature insofar as a material state is not changed. The moisture adsorption amount slightly increases on the lower temperature side in many practical cases. In the present moisture adsorbent, however, the moisture adsorption amount significantly increases under the high-temperature and high-humidity condition and is greatly suppressed under the low-temperature and high-humidity condition. This indicates that the present moisture adsorbent effectively exhibits the function under the high-temperature and high-humidity condition, and that the regeneration can be performed not only at the low humidity, but also under the low-temperature and high-humidity condition. In other words, the dehumidification filter using the present moisture adsorbent can be regenerated even under the high-humidity condition during the rainy season.

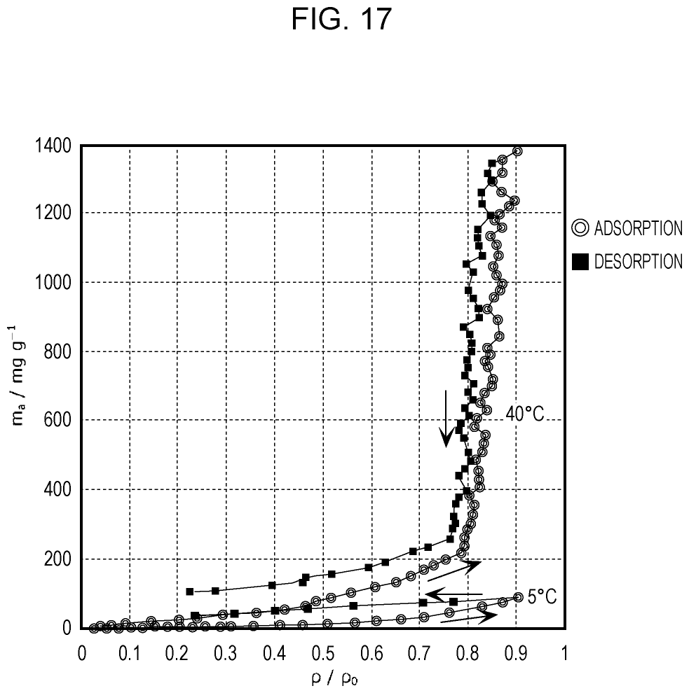

Because the moisture adsorption occurs to some extent during the pulverization of the material, adsorption of water vapor was measured with a constant-volume adsorption measurement device after vacuum drying at 70° C. inside the device. FIG. 17 is a graph representing an adsorption isotherm and a desorption isotherm of water vapor. A horizontal axis in the graph of FIG. 17 denotes relative pressure, and a vertical axis denotes an adsorption amount and a desorption amount of the water vapor. As represented in FIG. 17, it is found that, in the case of 40° C., an abrupt increase of the moisture adsorption amount occurs at the relative humidity of higher than or equal to 0.8 (corresponding to the relative humidity of 80%, but in the case of 5° C., such an abrupt increase of the moisture adsorption amount does not occur.

### Polymeric Moisture Adsorbent

A polymeric moisture adsorbent with the upper critical solution temperature used in the above-described embodiments is described.

When the polymeric moisture adsorbent is a crosslinked material, the adsorbent becomes a polymer gel that has swollen by absorbing moisture. While a dried substance of the polymer gel is used in the present disclosure, the dried substance does not need to be completely dehydrated insofar as it can adsorb moisture in gas.

The polymeric moisture adsorbent used in the present disclosure may be any of polyacrylamide, polyacrylonitrile, polyallylamine, polystyrene, polyvinyl alcohol, polyvinyl pyrazole, polyethylene oxide, polyacrylic acid, poly-(N-polyvinyl imidazole), derivatives thereof, and copolymers of those macromolecules.

The polymeric moisture adsorbent used in the present disclosure may also be any of multidimensional random copolymers, block copolymers, or graft copolymers having repetition units of polymers that are given by betaine polymers such as poly(diallyldimethylammonium) chloride, polysulfobetaine polymers such as poly2-(methacryloyloxy)ethyldimethyl-(3-sulfopropyl)ammonium hydroxide, or ureido polymers.

The polymeric moisture adsorbent used in the present disclosure may also be a copolymer of acrylamide and acrylonitrile with a nonionic structure, the copolymer being polymerized by the surface-initiated atom transfer radical polymerization method (see Krzysztof M. et al., Langmuir, 23 4528 (2007) and Seuring J. et al., Macromolecules, 45 3910 (2012)).

The polymeric moisture adsorbent used in the present disclosure may also be a copolymer of N-acryloyl glycinamide and acrylonitrile with the stable upper critical solution temperature (see Florian K. et at, Polymer Chemistry, 55 274 (2017)).

The polymer with the upper critical solution temperature may also be a cross-linked material of the above-mentioned macromolecules. That polymer may be, for example, a polymer obtained by polymerizing any of the above-mentioned monomers or two or more of the above-mentioned monomers with the presence of a crosslinking agent.

The crosslinking agent may be, for example, a combination of a crosslinking monomer such as ethylene glycol di(meth)acrylate, propylene glycol di(meth)acrylate, N,N′-methylene bis (meth)acrylate, tolylene diisocyanate, divinylbenzene, polyethylene glycol di(meth)acrylate, glutaraldehyde, multivalent alcohol, multivalent amine, multivalent carboxylic acid, a calcium ion, and a metal ion such as a zinc ion. Those crosslinking agents may be used alone or in a combination of two or more among those crosslinking agents.

The polymer with the upper critical solution temperature used in the present disclosure may also be a polymer forming an inter-penetrating polymer network structure or a semi-inter-penetrating polymer network structure together with another crosslinked or not-crosslinked polymer.

A production method can be selected as appropriate from known related-art methods. The polymer used in the present disclosure can be produced with, for example, freeze drying or vacuum drying.

The above-mentioned polymers may be borne on a ceramic monolithic honeycomb or a ceramic corrugated honeycomb.

From the above description, it is apparent to those skilled in the art that many improvements and other embodiments of the present disclosure can be conceived. Thus, the above description should be interpreted as merely illustrative and is provided with intent to teach those skilled in the art the best form implementing the present disclosure. The operation conditions, the compositions, the structures, and/or the function in the present disclosure can be substantially changed without departing from the gist of the present disclosure.

### Advantageous Effects and so on.

The dryer 1 includes the dehumidification filter 4 containing the temperature responsive material with the upper critical solution temperature, the fan 3 sending gas through the dehumidification filter 4, the heater 2 heating the dehumidification filter 4, and the controller 20 controlling the fan 3 and the heater 2 and switching the operation mode of the fan 3 and the heater 2 between the drying mode and the regeneration mode, wherein, in the drying mode, the object 30 to be dried is dried with the fan 3 sending the gas through the dehumidification filter 4 that is heated by the heater 2 to temperature higher than or equal to the upper critical solution temperature, and in the regeneration mode, the dehumidification filter 4 is regenerated with the fan 3 sending the gas through the dehumidification filter 4 at temperature lower than the upper critical solution temperature. When taking a long time is allowed to regenerate the dehumidification filter, the fan 3 may not need to be operated during the regeneration.

With the feature described above, the dryer 1 can efficiently perform the dehumidification by utilizing the properties of the temperature responsive material with the upper critical solution temperature. Accordingly, the dryer 1 can dry the object 30 to be dried with lower power consumption than the related-art dryer.

For instance, in the drying mode of the dryer 1, the fan 3 may send gas, received from the space 40 in which the object 30 to be dried is present, through the dehumidification filter 4 and supplies the gas to the space 40.

With the feature described above, the dryer 1 can dehumidify again the gas after being used to dry the object 30 to be dried and can supply the dehumidified gas, as high-temperature and low-humidity gas, to the space 40. Accordingly, the dryer 1 can perform the operation with lower power consumption.

For instance, in the regeneration mode of the dryer 1, the fan 3 sends gas, received from the space 40 in which the object 30 to be dried is present, through the dehumidification filter 4.

With the feature described above, the dryer 1 can regenerate the dehumidification filter 4. Accordingly, the dryer 1 can efficiently perform the operation.

For instance, in the regeneration mode of the dryer 1, the fan 3 sends gas after flowing through the dehumidification filter 4 to the outside of the space 40 in which the object 30 to be dried is present.

With the feature described above, the dryer 1 can discharge, to the outdoor, the gas containing moisture after being used to regenerate the dehumidification filter 4 and can avoid highly humid gas from coming into the space 40 in which the object 30 to be dried is present. Accordingly, the dryer 1 can efficiently perform the operation.

For instance, the dryer 1 further includes the flow path switching mechanism 5 switching the flow path of the gas in accordance with control by the controller 20. In the drying mode, the flow path switching mechanism 5 switches the flow path to a first flow path along which the gas is circulated between the space 40 in which the object 30 to be dried is present and the dehumidification filter 4, and in the regeneration mode, the flow path switching mechanism 5 switches the flow path to a second flow path along which the gas is discharged to the outside of the space 40 in which the object 30 to be dried is present through the dehumidification filter 4 from the space 40 in which the object 30 to be dried is present.

With the feature described above, the dryer 1 can switch the flow path of the gas between the drying mode and the regeneration mode and can utilize, to regenerate the dehumidification filter 4, the gas in the space 40 in which the object 30 to be dried is present. Accordingly, the dryer 1 can efficiently perform the operation.

For instance, the dryer 1 further includes the flow path switching mechanism 5 switching the flow path of the gas in accordance with control by the controller 20. In the drying mode, the flow path switching mechanism 5 switches the flow path to a first flow path along which the gas is circulated between the space 40 in which the object 30 to be dried is present and the dehumidification filter 4, and in the regeneration mode, the flow path switching mechanism 5 switches the flow path to a second flow path along which gas outside the space 40 in which the object 30 to be dried is present flows through the dehumidification filter 4 and is discharged to the outside of the space 40 in which the object 30 to be dried is present.

With the feature described above, the dryer 1 can switch the flow path of the gas between the drying mode and the regeneration mode and can utilize, to regenerate the dehumidification filter 4, the gas outside the space 40 in which the object 30 to be dried is present. Accordingly, the dryer 1 can efficiently perform the operation.

For instance, the dryer 1 further includes a pipe in communication with the outside of the space 40 in which the object 30 to be dried is present, the flow path switching mechanism 5 is composed of the pipe and the damper 5a disposed in the pipe, and the controller 20 switches the flow path by controlling opening and closing of the damper 5a.

With the feature described above, the dryer 1 can switch the flow path of the gas with the damper 5a between when the gas is delivered to the space 40 and when the gas is discharged to the outside of the space 40.

For instance, in the drying mode of the dryer 1, the controller 20 closes the damper 5a and controls the fan 3 such that the gas in the space 40 in which the object 30 to be dried is present flows through the dehumidification filter 4 and is supplied to the space 40.

With the feature described above, by closing the damper 5a in the drying mode, the dryer 1 can convert the gas in the space 40 to high-temperature and low-humidity gas and can supply the high-temperature and low-humidity gas to the space 40.

For instance, the dryer 1 further includes a pipe in communication with the outside of the space 40 in which the object 30 to be dried is present, the flow path switching mechanism 5 is composed of the pipe and the damper 5a disposed in the pipe, and the controller 20 switches the flow path by controlling opening and closing of the damper 5a. In the regeneration mode, the controller 20 opens the damper 5a and controls the fan 3 such that the gas in the space 40 in which the object 30 to be dried is present flows through the dehumidification filter 4 and is sent in a direction in which the gas is discharged to the outside of the space 40 via the pipe.

With the feature described above, by opening the damper 5a in the regeneration mode, the dryer 1 can discharge the gas after being used to regenerate the dehumidification filter 4 to the outside of the space 40.

For instance, in the dryer 1, an inner space of the pipe may be divided into routes, the divided routes extending parallel to an extending direction of the pipe.

With the feature described above, the dryer 1 can realize gas flow paths by using one pipe.

For instance, in the regeneration mode of the dryer 1, the controller 20 controls the fan 3 such that the gas outside the space 40 in which the object 30 to be dried is present flows through the dehumidification filter 4 via one of the routes, and the controller 20 opens the damper 5a disposed in another one of the routes and discharges, via the other route, the gas after flowing through the dehumidification filter 4 to the outside of the space 40 in which the object 30 to be dried is present.

With the feature described above, the dryer 1 can utilize the gas outside the space 40 to regenerate the dehumidification filter 4 and can discharge the gas with high humidity after being used to regenerate the dehumidification filter 4 to the outside of the space. Accordingly, the dryer 1 can efficiently perform the operation.

For instance, in the dryer 1, the object 30 to be dried may be a bathroom or an object present in the bathroom.

With the feature described above, the dryer 1 can function as a bathroom dryer.

For instance, the object 30 to be dried may include dishes, kitchenware, cutlery, or chopsticks.

With the feature described above, the dryer 1 can function as a dish (tableware) dryer.

For instance, the object 30 to be dried may include beddings or Japanese-style beddings.

With the feature described above, the dryer 1 can function as a bedding dryer.

For instance, a high-temperature moisture adsorption amount of the temperature responsive material, representing a moisture adsorption amount at relative humidity of higher than or equal to 80% and temperature higher than 30°, may be greater than a low-temperature moisture adsorption amount of the temperature responsive material, representing a moisture adsorption amount at temperature higher than or equal to 0° and lower than or equal to 30°.

With the feature described above, the dryer 1 has sufficient moisture adsorption performance under the high-temperature and high-humidity condition and can sufficiently regenerate the dehumidification filter under the low-temperature and high-humidity condition.

For instance, a difference between the high-temperature moisture adsorption amount and the low-temperature moisture adsorption amount of the temperature responsive material may be greater than or equal to 0.1 (g-H₂O/g-dry weight of the temperature responsive material).

With the feature described above, the dryer 1 has sufficient moisture adsorption performance under the high-temperature and high-humidity condition and can sufficiently regenerate the dehumidification filter under the low-temperature and high-humidity condition.

For instance, the temperature responsive material may be a copolymer of N-acryloyl glycinamide and acrylonitrile.

With the feature described above, the dryer 1 can include the dehumidification filter with the stable upper critical solution temperature.

For instance, the dehumidification filter may be removable with respect to a body of the dryer 1.

With the feature described above, the dryer 1 can include the dehumidification filter 4 with high quality.

For instance, the dryer 1 includes a dehumidification filter containing a temperature responsive material with an upper critical solution temperature, a fan sending gas through the dehumidification filter, a heater heating the dehumidification filter, and a controller controlling the fan and the heater and switching an operation mode of the fan and the heater between a drying mode and a regeneration mode. In the drying mode, an object to be dried is dried with the fan sending the gas through the dehumidification filter that is heated by the heater to temperature higher than or equal to the upper critical solution temperature, and in the regeneration mode, the dehumidification filter is regenerated with natural releasing of moisture from the dehumidification filter at temperature lower than the upper critical solution temperature.

With the feature described above, the dryer 1 can perform the drying with less electric power than in the related art. Accordingly, the dryer 1 can reduce energy consumed during the drying.

The drying method according to the embodiment includes drying the object 30 to be dried with the fan 3 sending gas through the dehumidification filter 4 containing the temperature responsive material with the upper critical solution temperature, the dehumidification filter being heated by the heater 2 to temperature higher than or equal to the upper critical solution temperature, and regenerating the dehumidification filter 4 with the fan 3 sending the gas through the dehumidification filter 4 at temperature lower than the upper critical solution temperature.

With the feature described above, the drying method can provide similar advantageous effects to those obtained with the above-mentioned dryer.

### Others

The embodiments have been described above, but the present disclosure is not limited to the above-described embodiments.

For instance, in the above-described embodiments, a process executed by a particular processor may be executed by another processor. The order of processes may be changed, and processes may be executed in parallel.

In the above-described embodiments, individual constituent elements may be realized with execution of software programs suitable for the constituent elements. The constituent elements may be realized with a program executer, such as a CPU or a processor, reading out the software programs recorded on a hard disk or a semiconductor memory, for example, and executing the software programs.

The constituent elements may be realized with hardware. For instance, the constituent elements may be circuits (or integrated circuits). Those circuits may constitute one circuit as a whole or may be separate circuits. Those circuits may be universal circuits or dedicated circuits.

Generic or specific embodiments of the present disclosure may be implemented in the form of a system, a device, a method, an integrated circuit, a computer program, or a recording medium such as a computer-readable CD-ROM. The generic or specific embodiments of the present disclosure may be implemented in any selective combinations of a system, a device, a method, an integrated circuit, a computer program, or a recording medium.

For instance, the present disclosure may be realized as a program for operating a computer to execute the drying method according to the above-described embodiment.

The present disclosure may be realized as a computer-readable non-transitory recording medium on which the above-mentioned program is recorded.

The present disclosure further includes other variously modified embodiments conceivable by those skilled in the art in connection with the above-described embodiments or embodiments realized with selective combinations of the constituent elements and the functions in the above-described embodiments within the scope not departing from the gist of the present disclosure.

The dryer according to the present disclosure can be utilized as a dryer capable of more efficiently performing drying with warm gas than in the related art.

What is claimed is:

1. A dryer comprising:
a dehumidification filter containing a temperature responsive material with an upper critical solution temperature;
a fan sending gas through the dehumidification filter;
a heater heating the dehumidification filter; and
a controller controlling the fan and the heater and switching an operation mode of the fan and the heater between a drying mode and a regeneration mode,
wherein, in the drying mode, an object to be dried is dried with the fan sending the gas through the dehumidification filter that is heated by the heater to temperature higher than or equal to the upper critical solution temperature, and
in the regeneration mode, the dehumidification filter is regenerated with the fan sending the gas through the dehumidification filter at temperature lower than the upper critical solution temperature.

2. The dryer according to claim 1, wherein, in the drying mode,
the fan sends gas, received from a space in which the object to be dried is present, through the dehumidification filter and supplies the gas to the space.

3. The dryer according to claim 1, wherein, in the regeneration mode,
the fan sends gas, received from a space in which the object to be dried is present, through the dehumidification filter.

4. The dryer according to claim 1, wherein, in the regeneration mode,
the fan sends gas after flowing through the dehumidification filter to an outside of a space in which the object to be dried is present.

5. The dryer according to claim 1, further comprising a flow path switching mechanism switching a flow path of the gas in accordance with control by the controller,
wherein, in the drying mode, the flow path switching mechanism switches the flow path to a first flow path along which the gas is circulated between a space in which the object to be dried is present and the dehumidification filter, and
in the regeneration mode, the flow path switching mechanism switches the flow path to a second flow path along which the gas is discharged to an outside of the space in which the object to be dried is present through the dehumidification filter from the space in which the object to be dried is present.

6. The dryer according to claim 1, further comprising a flow path switching mechanism switching a flow path of the gas in accordance with control by the controller,
wherein, in the drying mode, the flow path switching mechanism switches the flow path to a first flow path along which the gas is circulated between a space in which the object to be dried is present and the dehumidification filter, and
in the regeneration mode, the flow path switching mechanism switches the flow path to a second flow path along which gas outside the space in which the object to be dried is present flows through the dehumidification filter and is discharged to an outside of the space in which the object to be dried is present.

7. The dryer according to claim 5, wherein the flow path switching mechanism includes a pipe in communication with the outside of the space in which the object to be dried is present, and a damper disposed in the pipe, and
the controller switches the flow path by controlling opening and closing of the damper.

8. The dryer according to claim 7, wherein, in the drying mode,
the controller closes the damper and controls the fan such that the gas in the space in which the object to be dried is present flows through the dehumidification filter and is supplied to the space.

9. The dryer according to claim 5, wherein the flow path switching mechanism includes a pipe in communication with the outside of the space in which the object to be dried is present, and a damper disposed in the pipe,
the controller switches the flow path by controlling opening and closing of the damper, and
in the regeneration mode,
the controller opens the damper and controls the fan such that the gas in the space in which the object to be dried is present flows through the dehumidification filter and is sent in a direction in which the gas is discharged to the outside of the space via the pipe.

10. The dryer according to claim 6, wherein the flow path switching mechanism includes a pipe in communication with the outside of the space in which the object to be dried is present and a damper disposed in the pipe, and
the controller switches the flow path by controlling opening and closing of the damper, and
an inner space of the pipe is divided into routes, the divided routes extending parallel to an extending direction of the pipe.

11. The dryer according to claim 10, wherein, in the regeneration mode,
the controller controls the fan such that the gas outside the space in which the object to be dried is present flows through the dehumidification filter via one of the routes, and
the controller opens a damper disposed in another one of the routes and discharges, via the other route, the gas after flowing through the dehumidification filter to the outside of the space in which the object to be dried is present.

12. The dryer according to claim 1, wherein the object to be dried is a bathroom or an object present in the bathroom.

13. The dryer according to claim 1, wherein the object to be dried includes dishes, kitchenware, cutlery, or chopsticks.

14. The dryer according to claim 1, wherein the object to be dried includes beddings.

15. The dryer according to claim 1, wherein a high-temperature moisture adsorption amount of the temperature responsive material, representing a moisture adsorption amount at relative humidity of higher than or equal to 80% and temperature higher than 30°, is greater than a low-temperature moisture adsorption amount of the temperature responsive material, representing a moisture adsorption amount at temperature higher than or equal to 0° and lower than or equal to 30°.

16. The dryer according to claim 15, wherein a difference between the high-temperature moisture adsorption amount and the low-temperature moisture adsorption amount of the temperature responsive material is greater than or equal to 0.1 (g-H₂O/g-dry weight of the temperature responsive material).

17. The dryer according to claim 1, wherein the temperature responsive material is a copolymer of N-acryloyl glycinamide and acrylonitrile.

18. A dehumidification filter used in the dryer according to claim 1, the dehumidification filter being removable with respect to a body of the dryer.

19. A dryer comprising:
a dehumidification filter containing a temperature responsive material with an upper critical solution temperature;
a fan sending gas through the dehumidification filter;
a heater heating the dehumidification filter; and
a controller controlling the fan and the heater and switching an operation mode of the fan and the heater between a drying mode and a regeneration mode,
wherein, in the drying mode, an object to be dried is dried with the fan sending the gas through the dehumidification filter that is heated by the heater to temperature higher than or equal to the upper critical solution temperature, and
in the regeneration mode, the dehumidification filter is regenerated with natural releasing of moisture from the dehumidification filter at temperature lower than the upper critical solution temperature.

20. A drying method comprising:
drying an object to be dried with a fan sending gas through a dehumidification filter containing a temperature responsive material with an upper critical solution temperature, the dehumidification filter being heated by the heater to temperature higher than or equal to the upper critical solution temperature, and
regenerating the dehumidification filter with the fan sending the gas through the dehumidification filter at temperature lower than the upper critical solution temperature.

21. A dryer comprising:
a dehumidification filter containing a temperature responsive material with an upper critical solution temperature;
a controller executing a first process and a second process;
a fan; and
a heater,
wherein, in the first process, the controller causes the heater to heat the dehumidification filter to temperature higher than or equal to the upper critical solution temperature,
in the first process, the controller causes the fan to generate a gas flow that flows from a first region to a second region through the dehumidification filter heated to the temperature higher than or equal to the upper critical solution temperature and that reaches the first region from the second region, thereby the gas flow drying an object positioned in the second region,
in the second process, the controller causes the heater not to heat the dehumidification filter, thereby the temperature of the dehumidification filter being reduced to be lower than the upper critical solution temperature, and
in the second process, the controller causes the fan to generate a gas flow that flows from the second region to the first region through the dehumidification filter at temperature lower than the upper critical solution temperature and that reaches a third region from the first region.
